(19) United States
(12) Patent Application Publication
(10) Pub. No.: US 2018/0276227 A1
(43) Pub. Date: Sep. 27, 2018

(54) SYSTEM AND METHOD FOR CREATING AND SHARING CUSTOMIZED WEB FEEDS FROM A PLURALITY OF SOURCES

(71) Applicant: FanFaves, Inc., Dallas, TX (US)

(72) Inventors: MARK BOWRING, DALLAS, TX (US); BRIAN PALMER, DALLAS, TX (US); GLENN A. KIMBALL, DALLAS, TX (US); BRANDON FOSTER, DALLAS, TX (US); MICHAEL A. OSTMAN, JR., DALLAS, TX (US)

(21) Appl. No.: 15/936,932

(22) Filed: Mar. 27, 2018

Related U.S. Application Data
(60) Provisional application No. 62/477,153, filed on Mar. 27, 2017.

(51) Int. Cl. G06F 17/30

(52) U.S. Cl. CPC G06F 17/3089; G06F 17/30554; G06F 17/30377; G06F 17/30867

(57) ABSTRACT

A method for creating a customized web feed from a plurality of sources, comprising searching for a content source, displaying a plurality of content source selections from a source library, selecting at least one of the plurality of content source selections to be included within the customized web feed, displaying the at least one of the plurality of content sources, requesting, if a desired content source is not found within the plurality of content source selections displayed, that the desired content source is added to the source library, analyzing a potential content source to be added to the source library to determine a number of followers and a number of page views, determining whether the number of followers and page views of the potential content source exceeds a threshold, determining whether the potential content source has received a recent update, and adding the potential content source to the source library.

### BACKGROUND

The Internet provides a plethora of content distributed across many different websites and services. Therefore, what is needed are a system and method for creating and sharing customized web feeds from a plurality of sources.

### SUMMARY

In one aspect thereof, a method for creating a customized web feed from a plurality of sources is provided. The method comprises searching for a content source, displaying a plurality of content source selections from a source library, selecting at least one of the plurality of content source selections to be included within the customized web feed, displaying the at least one of the plurality of content sources, requesting, if a desired content source is not found within the plurality of content source selections displayed, that the desired content source is added to the source library, and adding the at least one of the plurality of content source selections to the source library.

In one embodiment, the method further comprises aligning the at least one of the plurality of content sources according to topic within the customized web feed.

In one embodiment, the method further comprises analyzing content, feed, and source usage data to establish trending.

In one embodiment, the method further comprises analyzing content, feed, and source usage data to establish key word and term usage and usage counts.

In one embodiment, the method further comprises analyzing a potential content source to be added to the source library to determine a number of followers and a number of page views, determining whether the number of followers and page views of the potential content source exceeds a threshold, and determining whether the potential content source has received a recent update.

In one embodiment, the at least one of the plurality of content source selections is periodically updated to include recent information from a source associated with the at least one of the plurality of content source selections.

In one embodiment, the method further comprises attempting to retrieve updated content from one or more sources in the source library according to an established update frequency, determining if updated content is available from the one or more sources in the source library, and altering the established update frequency.

In one embodiment, the method further comprises comparing a timestamp for previously updated content to a timestamp for currently available content from the one or more sources in the source library.

In one embodiment, altering the established update frequency includes a formulaic evaluation of a plurality of time periods, wherein each time period is an amount of time between each attempted content update.

In another aspect thereof, a system for use in creating a customized web feed from a plurality of sources is provided. The system comprises a processor and a memory coupled to the processor, the memory containing computer executable instructions for searching for a content source, displaying a plurality of content source selections from a source library, selecting at least one of the plurality of content source selections to be included within the customized web feed, displaying the at least one of the plurality of content sources, requesting, if a desired content source is not found within the plurality of content source selections displayed, that the desired content source is added to the source library, and adding the at least one of the plurality of content source selections to the source library.

In one embodiment, the system further comprises instructions for aligning the at least one of the plurality of content sources according to topic within the customized web feed.

In one embodiment, the system further comprises instructions for analyzing content, feed, and source usage data to establish trending.

In one embodiment, the system further comprises instructions for analyzing content, feed, and source usage data to establish key word and term usage and usage counts.

In one embodiment, the system further comprises instructions for analyzing a potential content source to be added to the source library to determine a number of followers and a number of page views, determining whether the number of followers and page views of the potential content source exceeds a threshold, and determining whether the potential content source has received a recent update.

In one embodiment, the at least one of the plurality of content source selections is periodically updated to include recent information from a source associated with the at least one of the plurality of content source selections.

In one embodiment, the system further comprises instructions for attempting to retrieve updated content from one or more sources in the source library according to an established update frequency, determining if updated content is available from the one or more sources in the source library, and altering the established update frequency.

In one embodiment, the system further comprises instructions for comparing a timestamp for previously updated content to a timestamp for currently available content from the one or more sources in the source library.

In one embodiment, altering the established update frequency includes a formulaic evaluation of a plurality of time periods, wherein each time period is an amount of time between each attempted content update.

In another aspect thereof, a method for optimizing source content retrieval frequency is provided. The method comprises attempting to retrieve updated content from one or more sources in a source library according to an established update frequency, comparing a timestamp for previously updated content to a timestamp for currently available content from the one or more sources in the source library, determining if updated content is available from the one or more sources in the source library, and performing a formulaic evaluation of a plurality of time periods, wherein each time period is an amount of time between each attempted content update, and altering the established update frequency.

In one embodiment, the method further comprises determining whether there is an alteration of content update behavior of the one or more sources, determining whether the alteration of the content update behavior is consistent with previously detected changes in content update behavior of the one or more sources, and creating an alternate update frequency schedule different from the established update frequency schedule.

### BRIEF DESCRIPTION OF THE DRAWINGS

For a more complete understanding, reference is now made to the following description taken in conjunction with the accompanying Drawings in which:

FIG. 1 illustrates a diagrammatic view of one embodiment of content source retrieval and customized feed creation system;

FIG. 2 illustrates a diagrammatic view of one embodiment of a combined feed webpage;

FIG. 3 illustrates a diagrammatic view of one embodiment of a source search webpage;

FIG. 4 illustrates a flowchart of one embodiment of a feed creation process;

FIG. 5 illustrates a flowchart of one embodiment of a content source selection process;

FIG. 6 illustrates a flowchart of one embodiment of a content source search process;

FIG. 7 illustrates a flowchart of one embodiment of a privacy and topic selection process;

FIG. 8 illustrates a flowchart of one embodiment of a source content prioritization process;

FIG. 9 illustrates a flowchart of one embodiment of a source gathering and indexing process;

FIG. 10 illustrates a flowchart of one embodiment of an automated source addition process;

FIG. 11 illustrates a flowchart of one embodiment of a source content retrieval frequency process;

FIG. 12 illustrates a flowchart of one embodiment of a retrieval frequency trend alteration process; and

FIG. 13 illustrates a diagrammatic view of one embodiment of a system device that may be used within the environment described herein.

### DETAILED DESCRIPTION

Referring now to the drawings, wherein like reference numbers are used herein to designate like elements throughout, various views and embodiments are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

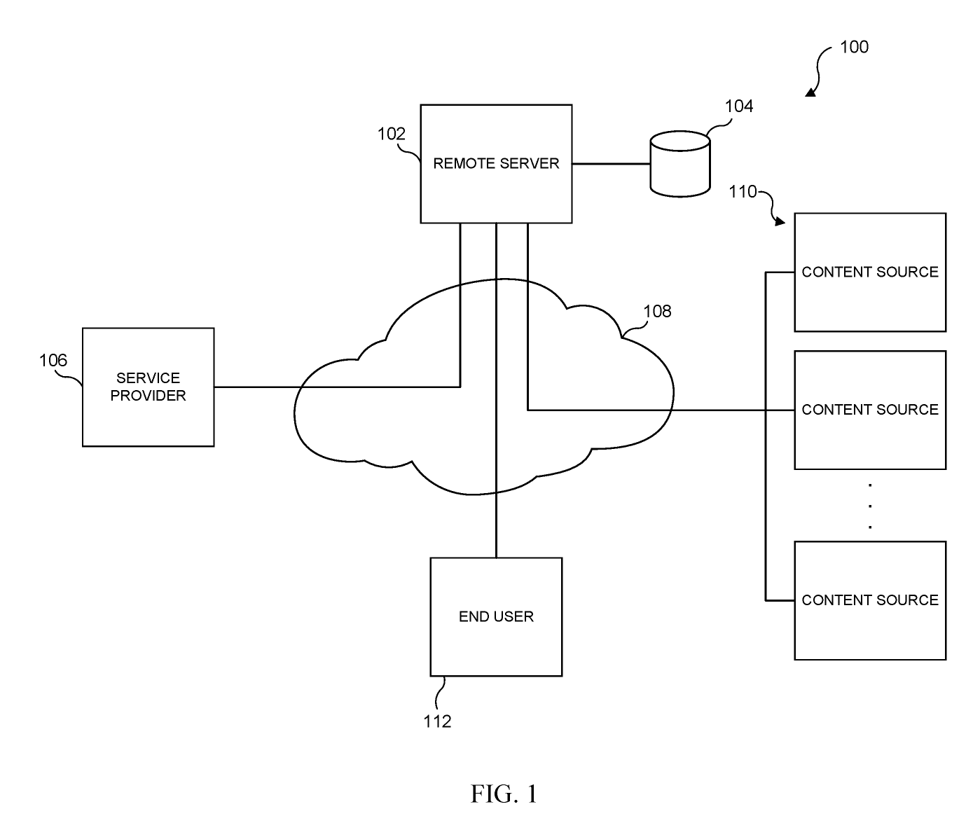

Referring now to FIG. 1, there is illustrated a content source retrieval and customized feed creation system 100. The system 100 includes a remote server 102 having a database 104. A service provider 106 connects to the remote server 102 over a network 108 to manage software, a website, and other features that allow for the content source retrieval and feed creation processes described herein. In some embodiments, the remote server 102 is local to the service provider 106, wherein the service provider 106 maintains the server 106 for use in the system 100. In other embodiments, the remote server 102 may be a cloud-based server offered by a cloud computing services entity such as Amazon Web Services or others, allowing for the service provider 106 to avoid the need to maintain its own hardware. The remote server 102 may act as a platform on which to develop software, to run updates and background processing, and to act as a web server to deliver a website providing the functionality described herein.

The remote server 102 may connect to a plurality of content sources 110 over the network 108. The plurality of content sources 110 may be any type of digital content that can be delivered over the network 108 to the remote server 102. For instance, the plurality of content sources 110 may include a Facebook page that provides content such as posts and other information, a Twitter page providing content such as individual tweets from a particular Twitter user, or Rich Site Summary (RSS) or Atom streams such as those provided by many news outlets through their websites. The plurality of content sources 110 may be polled and updated content retrieved by the remote server 102 to retrieve the latest content from the content sources. Many content sources may use their own Application Program Interface (API) that allows for content to be retrieved from the source. Alternatively, content sources may use a standardized protocol and format for propagating content from the content source, such as RSS or Atom.

The system 100 further includes an end user 112. It will be understood that there may be many end users and the users is a generalization for human or machine users. The end user 112 connects to the remote server 102 to utilize the system and services described herein whether through a technology-based client, application, or Application Programming Interface (“API”). In some embodiments, the end user 112 views a web site via a web browser application on a personal computer (PC) or mobile device. In other embodiments, the end user 112 may use an application stored on the PC or mobile device to access the features of the system and processes described herein. The end user 112 may select from the plurality of content sources 110 to create custom web feeds. These custom web feeds may be webpages that combine all of the content sources chosen by the end user 112 into a single webpage. The end user 112 may customize the content sources used for each created feed to create their own curated source of entertainment, news, and lifestyle interests. The remote server 102 polls the plurality of content sources 110 at certain defined intervals to keep the customized web feeds created by the end user 112 up to date with the latest posts, articles, and information associated with the content sources chosen by the end user 112. An alternative primary use of this system could include the acquisition of pre-aggregated content for use in downstream applications including, but not limited to, data analytics and content distribution, including offering paid distribution services of aggregated data and content.

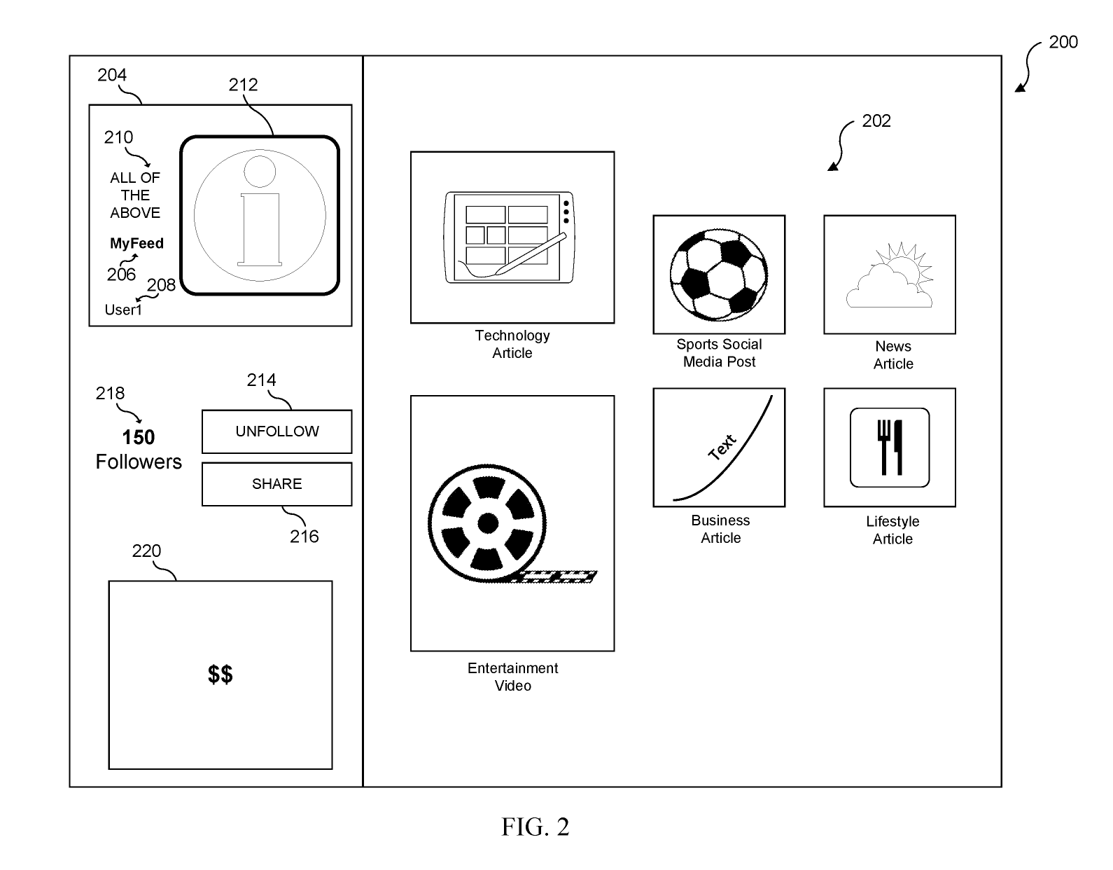

Referring now to FIG. 2, there is illustrated one embodiment of a combined feed webpage 200. The webpage 200 shows how a plurality of web sources 202 might be presented to a user of the website or application described herein. A user of the website or application may create the webpage 200 by selecting from a plurality of sources offered to the user from a library of sources, sources requested to be included by the user, sources searched by the user, requested for inclusion and added to the library of sources, or by other means. Each source included by the user would correspond to a select source of the plurality of web sources 202. The plurality of web sources 202 included on the webpage 200 may then be presented as separate tiles on the webpage 200, as shown in FIG. 2, with the tiles updating or being replaced as more recent content from each source associated with each web feed tile, or with the webpage 200 itself, is pushed out by the content provider of that feed. The tiles for the plurality of web sources 202 may also be rearranged as new content is received for each of the plurality of web sources 202. This rearrangement may be made according to various priorities, such as placing tiles for newer content near the top of the webpage 200, ordering tiles based on type of source (sports, entertainment, etc.), ordering tiles based on the source itself, or any other way of organizing the tiles.

The plurality of web sources 202 may provide content from any host source from which content can be retrieved, such as websites having an API or having RSS or Atom functionality. These host sources may provide content on a variety of different topics and interests, allowing users to tailor their web pages to specific sources, topics, or interests. For example, the plurality of web sources 202 shown in FIG. 2 includes an technology article from a source such as one specializing in reporting on new technological advances, a news article from a news source such as an article on the weather, a lifestyle article such as an article on a new restaurant in the user's area, and a business article from a source specializing in reporting business news. Each of these sources 202 would in turn be hosted on a host source denoting a website or other location that maintains one or more delineated and encapsulated sources of content and data. The plurality of web sources 202 may also include social media posts and other types of content such as videos, images, or any other content. For instance, the plurality of web sources 202 shown in FIG. 2 also includes a sports-related social media post. This may be a Twitter post from a sports team or a player, a Facebook post from the same, or any other type of post. The plurality of web sources 202 shown in FIG. 2 also includes an entertainment-related video, such as a YouTube video from one of the user's favorite YouTube content creators.

Thus, it will be appreciated that the plurality of web sources 202 may be made up of web sources and content from a variety of sources and categories of information. Essentially, if content can be taken from a website or other digital media platform by API or RSS or other formats and protocols that allow third parties to retrieve the content form the other websites or digital media platforms, this content can be reproduced on the webpage 200 within the plurality of web sources 202. In this way, users can create their own custom webpage that represents their interests, and this webpage can be shared with other users for those other users to view the content on the webpage 200.

The webpage 200 may further include information identifying the user and the content of the webpage 200. A custom webpage information tile 204 may be included on the webpage 200. The tile 204 may include information such as a title 206 of the custom feed webpage 200, a username 208 of the user who created the webpage 200, a category 210 for the webpage 200, and an image 212 associated with the webpage 200. The title 206 may be any title set by the user, but generally would be chosen to signal to other users what type of content is to appear on the webpage 200. The category 210 may be determined by the user, or may be selected from a plurality of category options provided by the service provider 106. In the example shown in FIG. 2, the category is “ALL OF THE ABOVE,” signaling to other users that the feed created by the user “User1” has a variety of topics included on the webpage 200. The image 212 may be any image that the user feels represents the content on the webpage 200, or may be selected from a selection of images provided by the service provider 106. The tile 204 may be reproduced on other webpages of the website or application provided by the service provider 106, such as on a main home screen of the website or application that shows to users other custom feed webpages created by other users. This would allow that user to select the tile 204 to be directed to the webpage 200 for viewing and interacting with the webpage 200.

The webpage 200 may also allow other users to follow or share the webpage 200. A follow/unfollow button 214 may be presented below the tile 204. The follow/unfollow button 214 allows the user currently logged in and viewing the webpage 200 to follow or unfollow the webpage 200. If following the webpage 200, a user may then see the tile 204 for the webpage 200 appear on other areas of the website or application, such as a “home” page of the website when the user first logs into the website. Multiple tiles for various webpages that the user is following may be presented to the user in this way, and may be organized in various ways, such as presenting the tile for the most recently updated webpage at the top of the “home” page.

A share button 216 may also appear near the follow/unfollow button 214. The share button 216 may allow users viewing the webpage 200 to either share the webpage 200 with other users of the website or application, allow the user to share the webpage 200 via social media (such as providing a link to, or sample content from, the webpage 200 in a Facebook post), email a link to the webpage 200, or any other means of making the webpage 200 or the content thereon known to others. Near the follow/unfollow button 214 and the share button 216, there may also be a followers counter 218 that displays the current follower count for the webpage 200. The webpage 200 may also include an advertising tile 220 for displaying advertisements to the user. Advertisements may also be displayed on feed webpages when viewed by other users, to allow for revenue sharing and other financial support for the service provider and users of the website or application.

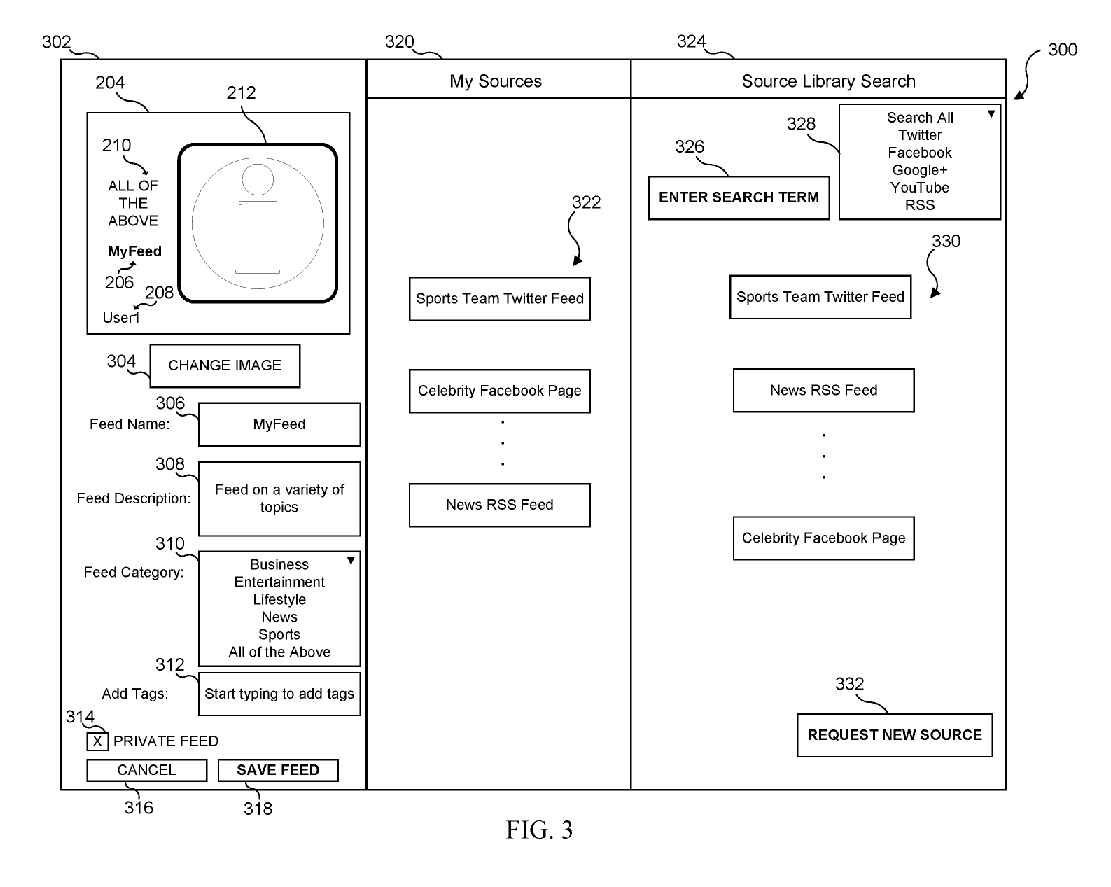

Referring now to FIG. 3, there is illustrated one embodiment of a feed creation webpage 300 which encapsulates one manifestation of the source search function. The feed creation webpage 300 includes a feed webpage information panel 302. The panel 302 includes the custom webpage information tile 204, which can be customized using the options presented in the panel 302. The panel 302 includes a “change image” button 304. The “change image” button 304 can be selected to allow a user to change the image 212 to a provided image or an image the user provides. Below the button 304 is a “feed name” field 306, which allows a user to enter the title 206 of the feed webpage. A “feed description” field 308 is presented below the “feed name” field 306, which allows the user to provide a text description for the feed webpage being created, generally relating to the types of content to be found on the feed webpage. Below that is a “feed category” drop down menu 310, which allows the user to select a category for the feed webpage. This category may be an all-encompassing category, such as the “all of the above” category, for example, or may be categories for specific types of content such as business, lifestyle, news, sports, or other categories.

Below the menu 310 there is presented an “add tags” field 312. The add tags field 312 allows a user to type in tags for the feed webpage. These tags are can be keywords used to identify a webpage as containing certain types of content, and can assist other users when searching for feed webpages having particular types of content. For example, if one user tags his or her feed webpage with “Boston Red Sox,” that user's feed webpage may be presented to other users that search for “Boston Red Sox,” or similar terms. Pre-defined tags or tags already created by users may also appear as a user types into the “add tags” field 312, allowing the user to select an option that appears as he is typing. For example, if the user typed into the “add tags” field 312 the letters “Boston Re” there may be displayed near the field 312 an option for “Boston Red Sox” that the user can select to complete the tag and have it added to the list of tags for the webpage.

Near the bottom of the feed webpage information panel 302 is a private feed checkbox 314. Checking this option allows a user to be the only one to see the feed webpage. There may also be an option for a semi-private feed, which may limit viewing of the webpage only to people the user has allowed access. Also near the bottom of the panel 302 is a cancel button 316, which ends the webpage creation process without creating a webpage, or without saving changes to an existing webpage. Next to the cancel button 316 is a “save feed” button 318, which, when selected, creates the customized feed webpage or saves changes to an existing feed webpage.

The webpage 300 also includes a webpage sources panel 320. The webpage sources panel 320 includes a plurality of selected sources 322. The plurality of selected sources 322 is a list of sources that have been chosen by the user creating or editing the feed webpage. The plurality of selected sources 322 are found by searching or requesting for the addition of sources on the user's feed webpage and may include a variety of sources, such as a Twitter feed for a sports team, a celebrity's Facebook page, or an RSS feed for a news website. Each of the plurality of selected sources 322 may be presented as a button that lists an identifier for the source. As the user selects each feed source to be included on the custom webpage, that source is added to the plurality of selected sources 322. Sources added to the plurality of selected sources 322 may be removed as well if the user decides he or she does not want a source to be included by selecting, or dragging off the panel 320, the button for that source.

The webpage 300 may also include a source library search panel 324. The source library search panel 324 includes a search field 326 that allows for search terms to be entered for use in performing a search. Various keywords may be entered, from source names to source types. For example, “Boston Red Sox” may be entered to bring up various Boston Red Sox sources, such as their official Twitter page, Facebook page, YouTube account, etc. Additionally, other search terms may retrieve the same or similar results, such as if the user entered “Boston” and “baseball.” In some embodiments, content may be further tailored to include specific types of content within specific sources. For example, a user might only want Facebook posts of the Boston Red Sox and “fans.” So, this may limit the sources, and content from the sources, to Facebook posts regarding fans of the Boston Red Sox, rather than the Boston Red Sox themselves. This may also simply retrieve content on both the Boston Red Sox and posts from or about their fans.

The source library search panel 324 may also include a source filter 328. The source filter 328 may be a drop down menu that lists a variety of sources. The selection of one of the sources will limit search results to that source. For instance, choosing “YouTube” from the source filter 328 will limit any results from using the search field 326 to YouTube sources. There if further shown in the source library search panel 324 a plurality of results 330. The plurality of results 330 lists the results of the search performed using the search field 326. The plurality of results 330 may be buttons that can be selected, or dragged into the webpage sources panel 324, to add the source to the plurality of selected sources 322. If a desired source is not found within the plurality of results 330, a user may select a “request new source” button 332, which begins a process that enables the user to request that a source not found within the service provider's source library be added to the library, or at least to the user's feed webpage.

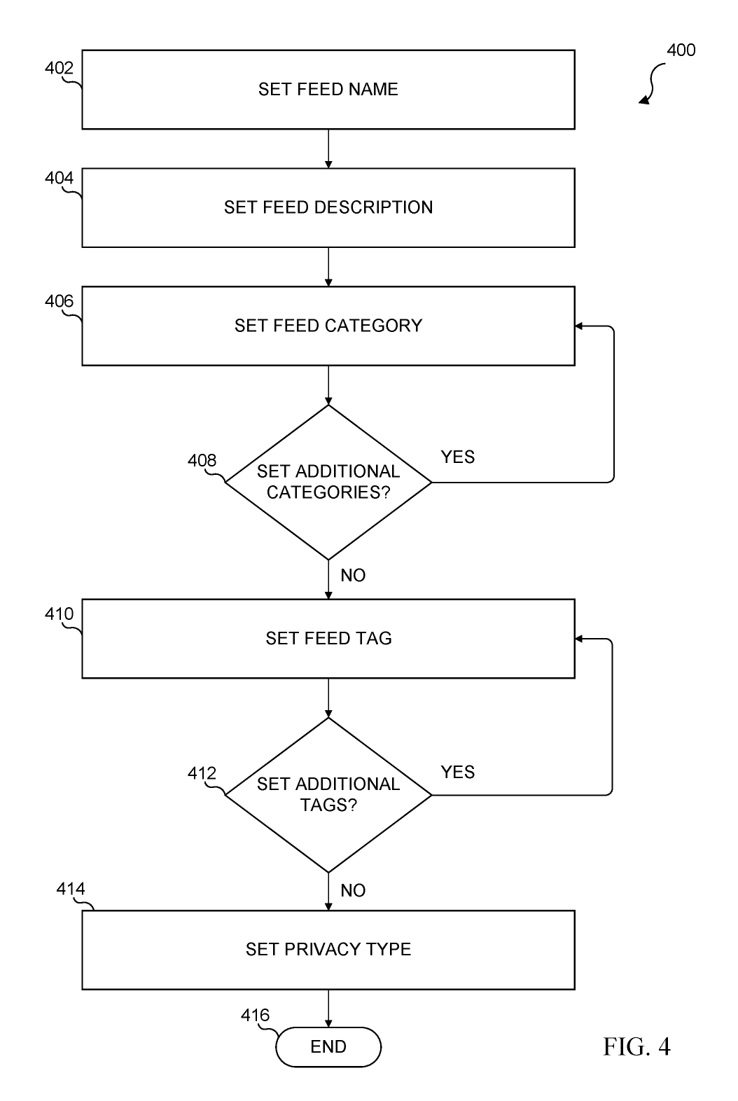

Referring now to FIG. 4, there is illustrated a flowchart of one embodiment of a feed creation process 400. The process 400 may be implemented using a graphical user interface (GUI) such as that shown in FIG. 3, or other interfaces for providing the necessary functionality to allow the process 400 to be performed. The process begins at step 402 at which a feed name is set. At step 404, a feed description is set. The feed description may be a description provided by the user that alerts others to the types of content provided by the feed on the feed webpage. At step 406, at minimum, one feed category is set. The process then flows to decision block 408, where it is determined whether additional categories are to be set. If so, the process moves back to step 406 to allow for another category to be added to a set of categories for the feed. If at decision block 408 it is determined that no additional categories are to be set, the process flows to step 410. At step 410, a feed tag is set. A feed tag can further differentiate and define a feed in addition to the name, description, and category, as a tag may be more specific or narrow than the other items and may also further assist in searching for the feed. At decision block 412, it is determined whether additional tags should be included. If so, the process moves back to step 410 to allow for another tag to be set. If at decision block 412 it is determined that no other tags are to be set, the process move to privacy settings, step 414. A feed may be set as a public, private, or semi-private feed, where a public feed is available for viewing by all users, a private feed is available for viewing only by the user who created it, and a semi-private feed is only available for viewing by the user who created it and users that are invited to view it. Once privacy is set the process ends at step 416.

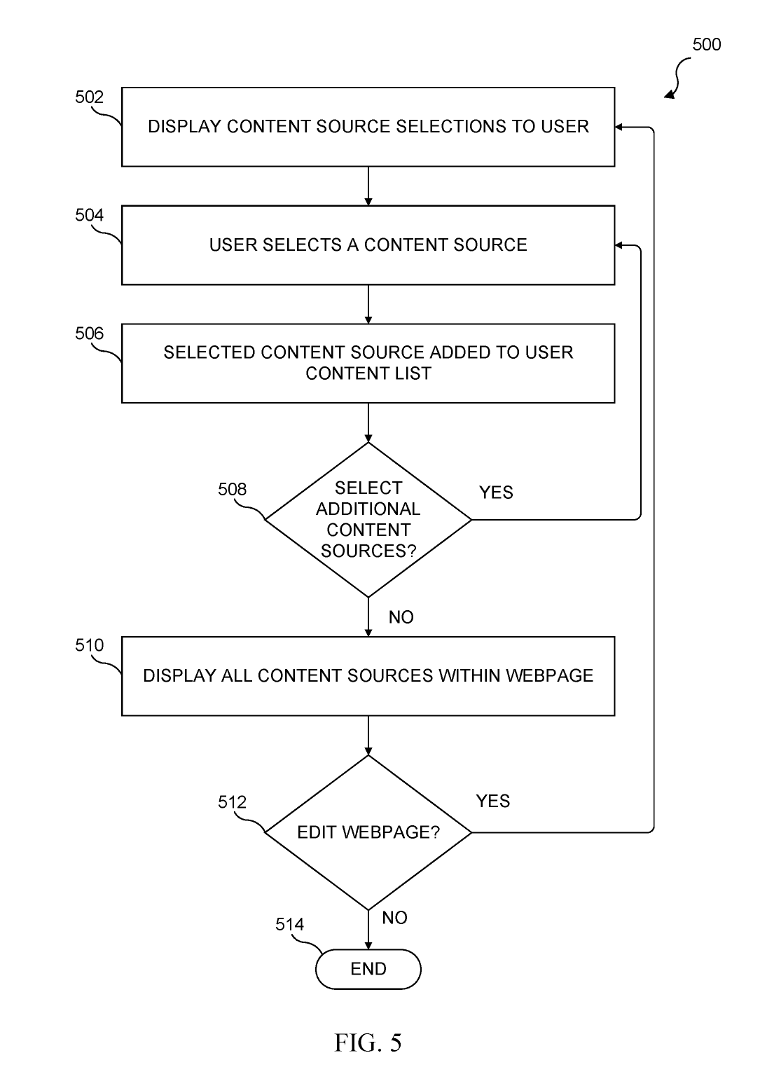

Referring now to FIG. 5, there is illustrated a flowchart of one embodiment of a content source selection process 500. The process 500 begins at step 502, where available content source selections are displayed to a user. The displayed content sources may be recommended sources based on user preference, popularity, found via a search performed by the user, or other methods of presenting the content sources to the user. At step 504, the user selects one of the displayed content sources that the user wishes to add to the user's feed webpage. At step 506, the selected content source is added to a user content list, the user content list being a list of all sources that have been selected by the user to be included on the feed webpage. At decision block 508, it is determined whether additional content sources are to be selected and added to the user content list. If so, the process moves back to step 504 to allows a user to select another one of the displayed content sources.

If at decision block 508 it is determined that no other content sources are to be added to the user content list, the process flows to step 510. At step 510, all of the selected content sources found in the user content list are displayed within the user's feed webpage, such as a webpage similar to that shown in FIG. 2. The process then flows to decision block 512 where it is determined whether the created webpage should be edited. If so, the process moves back to step 502 to again display the available content source selections to the user and begin the process anew. If it is determined at decision block 512 that no edits are to be made, the process ends at step 514.

The searching of sources is advantageous and an improvement because it allows for the searching of specific sources, rather than simply for content within sources. For example, a typical internet search using a search engine such as Google's search engine will retrieve results based on an algorithm that searches for keywords within indexed content, such as individual news articles or social media posts, with other parameters such as prioritizing advertising content and placing results in varying orders. However, the searches performed using the system described herein provides results for the sources of content themselves. For instance, when a search for “Boston Red Sox” is performed, instead of receiving various links to items such as a specific Twitter post or a specific news article concerning the Boston Red Sox, the system provides the user with a result that is the source itself, such as the overall Twitter feed for the Boston Red Sox or a news outlet that covers the Boston Red Sox. Thus, what is provided may not be specific Boston Red Sox content, but rather the sources themselves that provide Boston Red Sox content on an updating basis to the user if the user adds the source to the user's feed webpage.

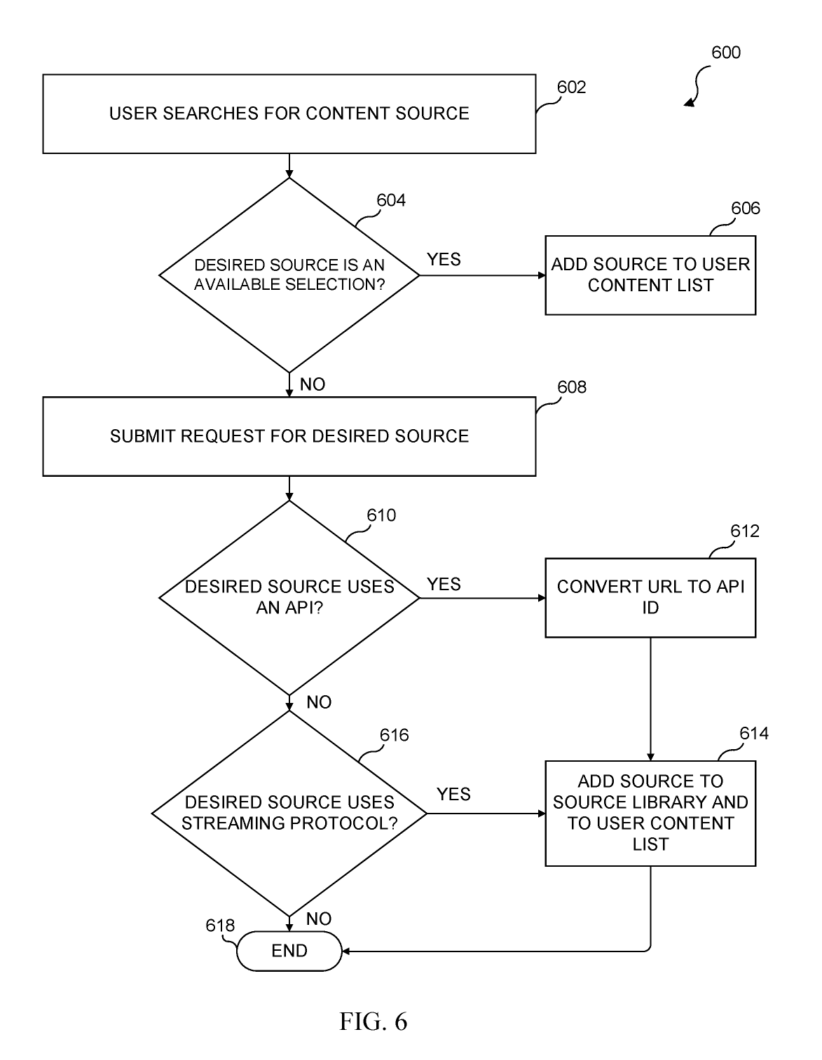

Referring now to FIG. 6, there is illustrated a flowchart of one embodiment of a content source search process 600. The process 600 begins at step 602 where a user performs a search for a content source, such as using the search functionality of the webpage described with respect to FIG. 3. The process then flows to decision block 604, where it is determined whether the desired source, i.e., the source the user is seeking to add to the user's webpage, is displayed as a result of the search. If it is displayed, the process moves to step 606, where the source is added to the user's content list. If at decision block 604 it is determined that the desired source is not an available selection, the process moves to step 608 where the user can submit a request for the desired source. There may be certain sources that a part of a source library that contains the sources saved in the database 104 and offered to users. However, users may want to include sources in their feeds concerning other sources not yet stored and offered natively by the system 100. Therefore, users may submit a request to have their desired source included in the source library.

The request may include the source type (Facebook, Twitter, RSS feed) and the URL for the page within that source. For example, the URL provided by the user may be “https://www.facebook.com/apple” for example. This URL identifies the source as Facebook and the page within that source, a page for Apple computers in this case. Once the source request is received, at decision block 610 it is determined whether the source uses an API. If so, the process flows to step 612 where the URL is converted, as necessary and required by the host source, to an API ID that can be used for retrieving the content from the source. The API ID is an ID number that identifies the page or user within that source. For instance, Apple's Facebook page may have an ID of 434174436675167. Using this ID, an API call can be used to retrieve the latest content for Apple's Facebook page, store it on the server 102, and reproduce it, link it, or otherwise make it available on a user's feed webpage. At step 614, the source is added to the source library, in order to now provide the source to other users who are searching for sources on the service provider's website or application when performing searches such as at step 602. As new API-based host sources are added to the repertoire of the FanFaves solution new API ID conversion use cases will be addressed by this method.

If the requested source does not utilize an API as determined at decision block 610, the process moves to decision block 616 to determine if the source uses a streaming protocol, such as RSS. If so, the process moves to step 616 to add the RSS source to the source library. If it is determined that the source does not use a streaming protocol, the process ends at step 618. As new streaming host sources are added to the repertoire of the FanFaves solution new streaming conversion use cases will be addressed by this method.

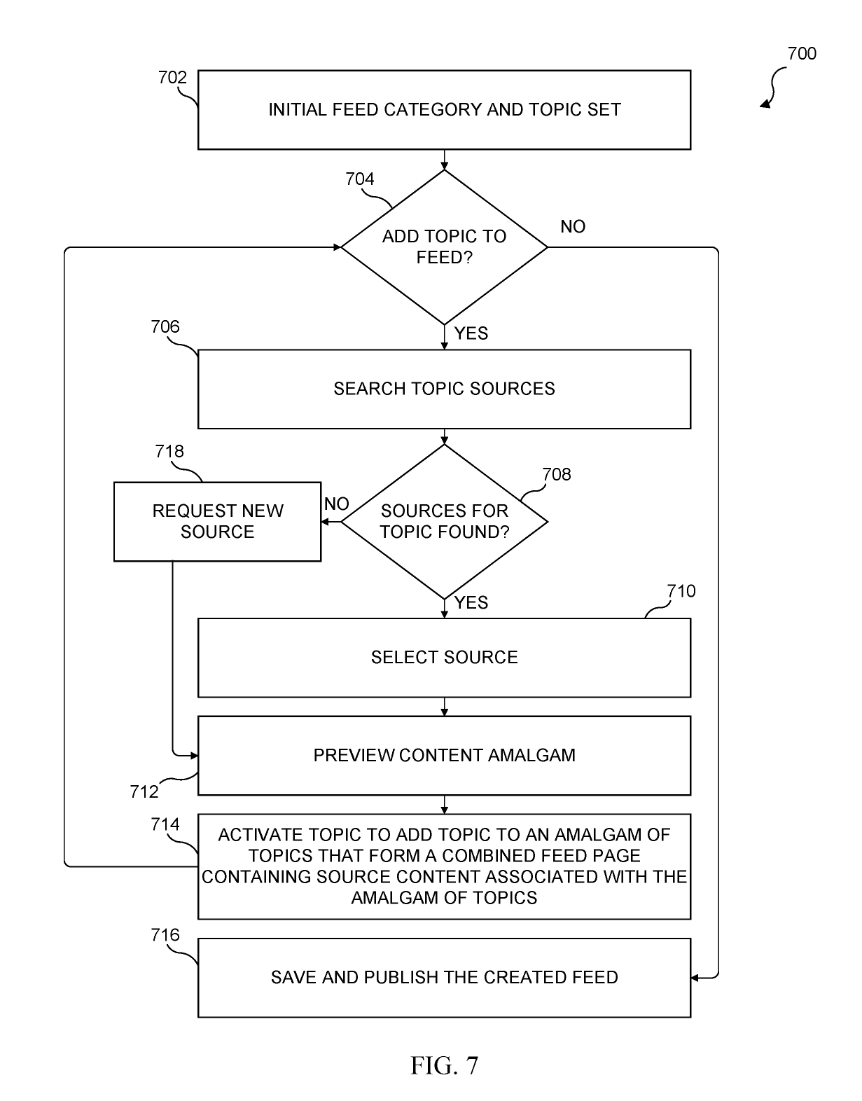

Referring now to FIG. 7, there is illustrated a flowchart of one embodiment of a topic inclusion process 700. Conceptually, a feed is only limited by the imagination of the feed creator. Despite categorization, tags, descriptions, and other defining characteristics, a feed is not limited to those definitions by way of the source selection process 500. Societal, psychological, and logic norms for most human systems is to establish logical boundaries that are inclusive of a specific subject and exclusive of ancillary, seeming unrelated subjects. However, the nature of human thought is truly not always linear and exclusive. As such the platform seeks to provide the flexibility for users to define feeds without boundaries. As such, the system seeks to provide the flexibility for a user to include seemingly unrelated topics acquired from disparate sources to establish a facility and function within which individual users may personalize their feeds in a topical manner. The system does not manifest the “Topic” in a concrete hierarchy, but provides the avenue to be inclusive regardless of the logical association. In pre-defined process 702 (Referring to process 500) the user has created the initial feed with its initial topic.

At step 704, it is determined whether a topic should be added to the feed. Topics represent specific items of coverage that align with the intent of the feed per the feed owner's definition. They may be comprised of select, related (or unrelated) content pages from a variety of sources. Each topic represents one source of data that may or may not be coherent to other topics.

Often topics will represent a variety of points-of-view that come together to represent “the whole picture” of a related subject. For example, a topic may be “Dallas Cowboys Football” which might be associated with the Dallas Cowboys Facebook, Twitter, and YouTube accounts, as well as the Dallas Cowboys official website or other related sources such as ESPN. The topic may ensure that no non-Cowboys related content is presented on the feed webpage by limiting, as an example, all ESPN content to content that includes a reference to the Cowboys. When content is published to the feed webpage, that content may be searched for keywords such as a combination of “Dallas,” “Cowboys,” and “football,” to ensure that the page only contains Dallas Cowboys information, even when content is retrieved from a source that is not specific to the Dallas Cowboys. In this way, topics can be used to narrowly-tailor custom feeds. Multiple topics may be chosen to even further narrow a feed webpage. For example, if a feed webpage having a topic of “the Dallas Cowboys” also added a topic for “sports cars,” in some embodiments the feed will include both the Dallas Cowboys sources and sports cars sources. However, in some embodiments the feed may be narrowed to include only content that contains both the Dallas Cowboys and sports cars, such as a Twitter post from a Dallas Cowboys player commenting on the purchase of a new Corvette. This allows for a feed webpage to be extremely focused on a particular theme. Topics may already be available within the system and searched for by users, whereas topics that do not appear in the database may be requested, much in the same way as requesting a source, except the topic may include multiple source URLs or other identifying information.

Topics already available within the system may be topics that are conventionally associated. For example, a topic that encompasses “food” and “restaurants” may be a conventional topic. However, it may not be conventional to associate “food” and “honey ants” within the same topic. Such unconventional associations would not be prohibited, however, as users are encouraged to create topics covering whatever amalgam of sources the user wishes to create.

If at decision block 704 it is determined that a topic is not to be added, the process moves to step 716 where the feed is saved and published. If at decision block 704 it is determined that a topic is to be added, the process moves to step 706 where a topic source is searched for by the user from the source library. This may be a keyword search, a tag search, or any other type of search that may also include filters or other tools for narrowing the search. At decision block 708, it is determined whether the topic source desired by the user is found within the selection of sources stored in the database. If so, the process moves to step 710 where the desired topic and one or more of the plurality of associated sources is(are) selected. At step 712 the topic is previewed to view the content of the topic to ensure that the content of the topic is desired to be included by the user. At step 714, the topic is activated to add the topic to an amalgam of topics that form the combined feed page containing the source content associated with the amalgam of topics, as described hereinabove. The process then moves back to decision block 704 to determine if additional topics sources should be selected or not.

If at decision block 708 it is determined that the desired topic could not be found within the database, the process moves to step 718 where the user can request a new source(s) related to the topic be added to the database. The information provided in the request may include a source name, a series of URLs or other source identifiers, and keywords or other identifiers that narrow the content to be included within the topic, such as including a keyword of “steak” when choosing lifestyle or culinary sources to limit the topic to steak-related content. After a request for a new topic via sources is made and the new sources are added to the database, the process moves to step 712 to carry out the rest of the process 700. This process supports trending analysis of key words for the system.

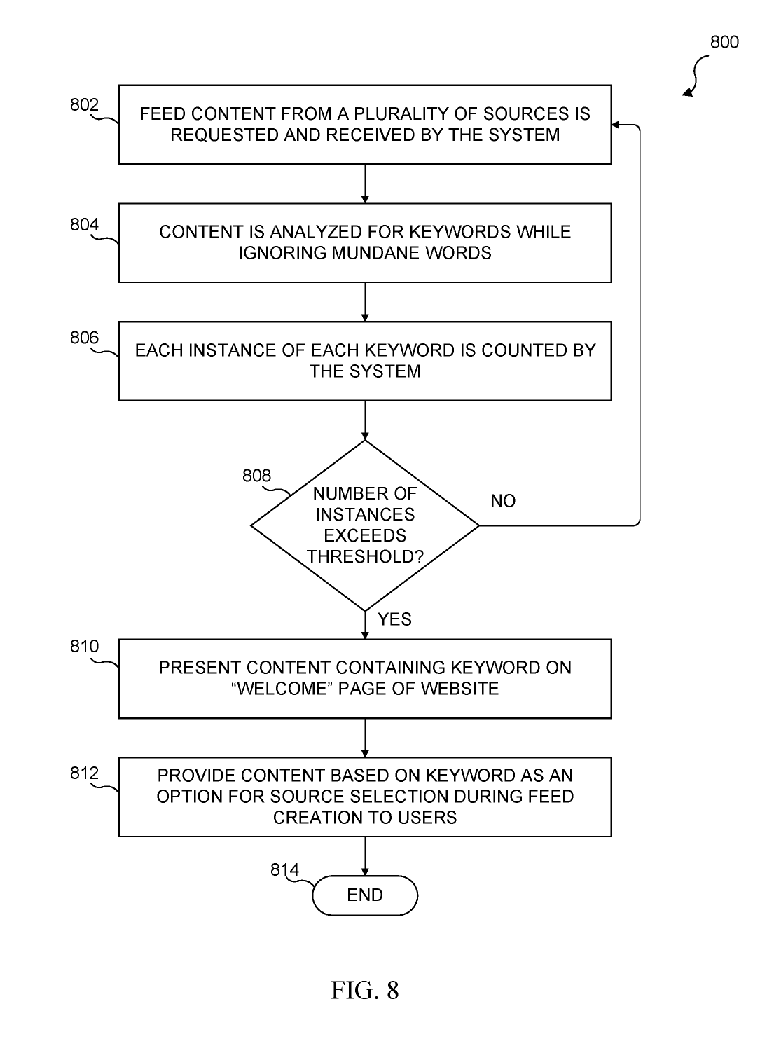

Referring now to FIG. 8, there is illustrated a flowchart of one embodiment of a source content prioritization process 800. At step 802, feed content from a plurality of sources is requested and received by the system. At step 804, the content received is analyzed for keywords while ignoring mundane words. For instance, the system may be configured to recognize when a proper noun is used, such as when a capitalized word is used in the middle of a sentence, while ignoring common words such as article adjectives. At step 806, each instance of each word identified as a keyword is counted by the system, across all content retrieved from the plurality of sources. At decision block 808, it is determined whether the number of instances of a keyword exceeds a threshold. This threshold may be a set integer, a percentage of usage across all other keywords identified, a percentage associated with an increase in usage (such as if a celebrity's name is used 50% more in the latest content received from the plurality of sources over the last time content was retrieved from the plurality of sources), or other means of identifying when a keyword is being used at a high rate. If the number of instances does not exceed the threshold, the process moves back to step 802.

If the number of instances does exceed the threshold, the process moves to step 810. At step 810, content containing the keyword may be presented on a “Welcome” or “Home” page of the website or application provided by the service provider. In other embodiments, the keyword may simply be identified has having a high amount of mentions and that keyword can be selected to view a feed of content containing that keyword. At step 812, the keyword may also be presented to users as they search for content and create new feeds. During the feed creation process, the users may see recommended keywords associated with keywords that have exceeded the threshold in decision block 808. Selecting these keywords would allow for the user to add those sources for content containing the keyword, or to select or request topics related to the keyword. At step 814 the process 800 ends.

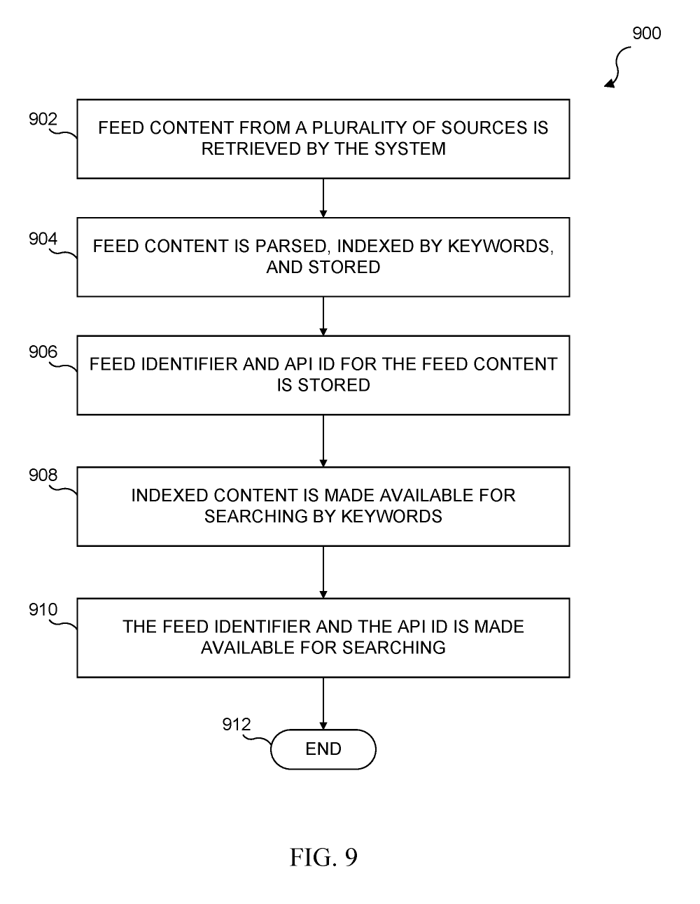

Referring now to FIG. 9, there is illustrated a flowchart of one embodiment of a source gathering and indexing process 900. The process 900 begins at step 902 where feed content is retrieved from a plurality of sources. At step 904, the feed content is parsed, indexed by keywords, and stored in the database. At step 906, the Feed Identifier and API ID for the feed content are stored. At step 908, the indexed content is made available for searching by the associated keywords. At step 910, the Feed Identifier and API ID are made available for searching as well. This allows for users who know the API ID, such as if the user knows the ID of the Facebook page the user wishes to include on the user's feed webpage, to search for the API ID to find specific content sources. The process ends at step 912.

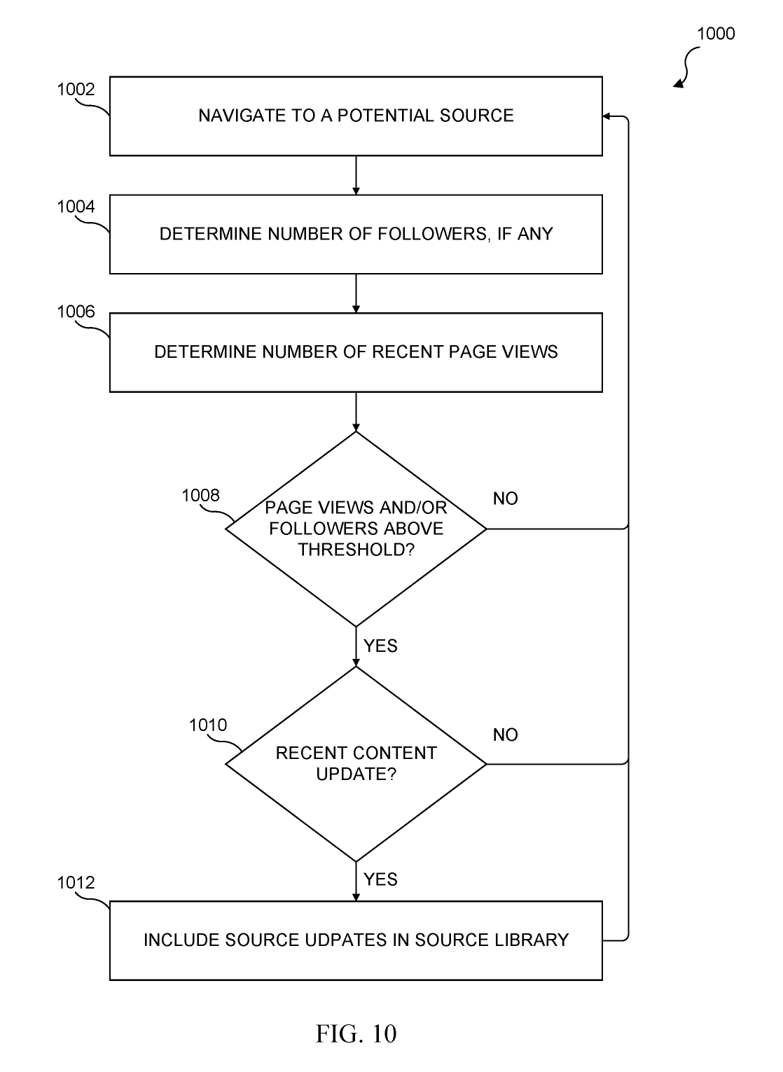

Referring now to FIG. 10, there is illustrated a flowchart of one embodiment of an automated source addition process 1000. The process 1000 begins at step 1002, where the system navigates to a potential source. This potential source may be a particular page within a known and used source, such as Facebook, where the potential source is a particular Facebook page, such as, for example, the Facebook page for Apple Computers. The system may cycle through potential sources on a periodic basis to reevaluate the potential source. For instance, the system may move to each Facebook page in sequential order via the API IDs for each Facebook page. The system may speed up such a process by only checking for pages flagged as business or otherwise non-individual based pages, such as Apple's Facebook or Twitter account, as, in some embodiments, there may be restrictions implemented by the source, or others, on pulling information from an individual's account. In other embodiments, the potential source may be one that is retrieved and indexed according to the process of FIG. 9, which allows the source to be analyzed offline since it will have already been stored by the server. At step 1004, the system determines the number of followers, if any, or equivalent statistics depending on the source, for the potential source. This may be accomplished via text recognition, via using the source's API to extract the follower number for the particular source page, or other methods. At step 1006, the number of recent page views is determined. “Recent” may be defined to be in the past day, week, month, etc.

At decision block 1008, it is determined if the number of page views and/or followers are above a threshold. This threshold may be an integer, a number greater than an average number of views or followers on similar source pages, or other means of identifying a moderate to high level of recent views and/or followers. In some embodiments, there may be a different threshold for page views and a different threshold for followers. In other embodiments, the number of page views and followers may be combined and evaluated against the threshold. If the number of page views and/or followers is not above the threshold, the process moves back to step 1002. If the number of page views and/or followers is above the threshold, the process moves to decision block 1010. At decision block 1010, it is determined whether the source page has been updated recently, such as in the past day or week. Depending on the type of source, “recent” may be defined differently. For example, for Twitter pages, “recent” may mean within a week, whereas for a blog it may be a month. This check is made because if a source has a large number of followers or overall page views, but the source has not been updated or provided with new content for an extended period of time, it may not be worth including the source if it might not provide any new, or at least infrequent, content updates. If it is determined that the source page has not been updated recently, the process moves back to step 1002. If it is determined at decision block 1010 that the source page has been updated recently, the process moves to step 1012. At step 1012, the source updates are included in the source library of the website or application. Thus, the method described with respect to FIG. 10 allows for the system to automatically grow and update the source library by determining the popularity or general ubiquity of a particular source.

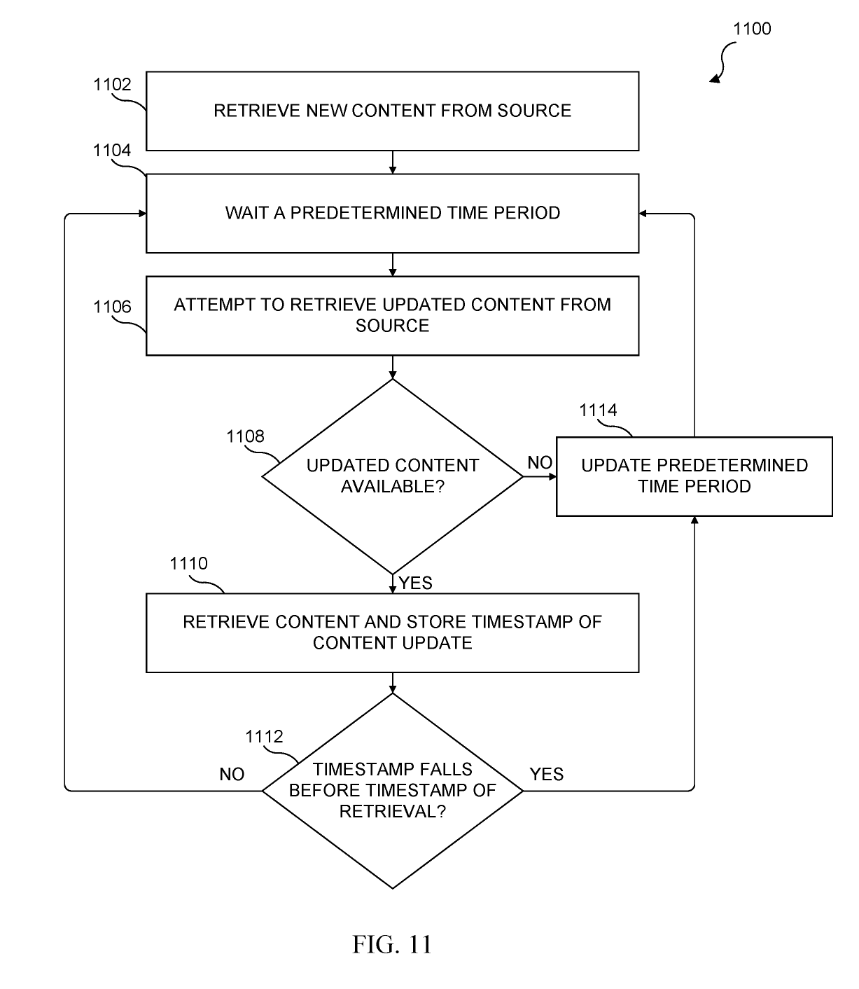

Referring now to FIG. 11, there is illustrated a flowchart of one embodiment of a source content retrieval frequency process 1100. To reduce the impact on the amount of resources used when attempting to keep all sources provided on the website or application up to date with the latest content from each source, the frequency of updates may be adjusted for each source, depending on the update frequency history for that source. Over time the system will become more and more efficient as the update frequency for sources is tracked and timing between polls of those sources is adjusted accordingly. This alleviates the strain on the server, as sources that are not updated frequently will not be polled as frequently as they might be on a simple, non-adaptable, set timing between polls. The process 1100 begins at step 1102 where new content is retrieved from a source. Step 1102 may be the first time content is retrieved from the source. If so, a standard delay period for the next retrieval may be set for the source based on the type of source and that source type's general update schedule. Select parameters within the system will provide minimal and maximal boundaries for source polling to ensure that the system by default does not over correct due to statistical anomalies produced at the source behavior level.

For example, if the new source is a Twitter source, it may be known that the timing between Tweets generally requires a more frequent timing than a source such as a blog having generally less frequent updates. Thus, the timing for the new source if it is a Twitter source, may be, as an example, initially set at a 30-minute delay, whereas the timing for a blog source may be set to one week. It will be understood that this delay with respect to how it is stored and implemented in the system may be set in seconds, minutes, hours, days, weeks, months, etc. For example, all timings may be represented in minutes, so an hour delay would be set to the value of 60, and a one month delay would be set to 43200, for example. The delays may also be set to a combination of these depending on the size of the delay value.

The process 1100 flows to step 1104 where the system waits the predetermined amount of time currently set for the particular source. At step 1106, the system attempts to retrieve any updated content from the source. At decision block 1108, it is determined whether the source upon the retrieval attempt in step 1106 had any updated content. This may be done by having stored within the system the timestamp for the previously retrieved content from the source, and checking the source for any content updates after that previously recorded timestamp. If the source does have updated content to be retrieved, the process 1100 moves to step 1110. At step 1110, the new content is retrieved and the timestamp for when the new content was published at the source is stored. If there is more than one item of new content, such as three new social media posts since the last retrieved post, for example, all the new items of content and their published timestamps would be stored. At decision block 1112, it is determined whether the timestamp(s) of the retrieved content falls before the time retrieval of the new content was initiated. This determination is made to analyze whether the predetermined time period from step 1104 was accurate. If so, and the timestamp of the new content retrieved in step 1110 falls on the same time as the time at which the retrieval was attempted, the predetermined time period is accurate for retrieving content from the particular source and the process moves back to step 1104 to wait the predetermined time period again before attempting another retrieval.

However, in most cases, the predetermined time period will not exactly match the timing of a content update for the source, as many sites do not provide content updates on an exact set schedule. In some embodiments, a small deviation may be allowed the process still returns to step 1104, such as, for example, if there is only a 10% difference. If at decision block 1112 it is determined that the timestamp(s) of the new content are before the time of retrieval, then the predetermined time period may need to be adjusted to more closely match a source's update schedule. Thus, the process 1100 moves to step 1114 to update the predetermined time period before moving back to step 1104 to wait for the, now updated, predetermined time period. The predetermined time period may be updated in various ways. For example, the amount of time between the timestamp for the newly retrieved content and the timestamp for the previously retrieved content may be, for instance, 50% of the amount of time set for the predetermined time period. So, if the predetermined time period is set to one hour, or 60 minutes, and the amount of time between the timestamp for the newly retrieved content and the previously attempted retrieval was 30 minutes, the predetermined time period may be shortened by 50% to attempt to more closely match the source's update schedule.

In some embodiments, the system may continuously adjust the predetermined time period based on all past data. For example, the predetermined time period may be a mean calculated for the timing gap across all retrieval attempts and the number of updates provided by the source. For instance, one such equation is

$$t = \frac{{\sum }_{k = 1}^{p} {g}_{k}}{p} ,$$

where t is the predetermined time period to be used, p is the number of total posts or updates recorded as being made by the source since retrievals from the source began being performed by the system, and gₖ is each gap recorded by the system between the timestamp for retrieved content and the timestamp for previously retrieved content. For example, if a source has been polled three times in the past, and the gaps in time between each content update were recorded as being 30 minutes (g₁), 20 minutes (g₂), and 90 minutes (g₃), the predetermined time period would be set to approximately 46.6 minutes (140/4). If the next retrieval had a gap of 60 minutes (g₄), the predetermined time period would then be t=50, a slight increase in the predetermined time period. As more and more updates are logged, the equation would be performed again and again, changing the predetermined time period on each appropriate retrieval event. It will be understood that this calculation would be performed for each individual source (separate Facebook users, Twitter accounts, YouTube channels, etc.), as each individual source may have different content update behavior depending on the host of the source.

Standard deviation may also be used to determine whether an adjustment of the predetermined time period should be adjusted or not. If a standard deviation is calculated for the accumulated set of time gaps between content posts, the system may not adjust the predetermined time period when a particular time gap is a certain number of standard deviations from the mean (such as if the gap length happens to be 6 standard deviations from the mean, for example). The system may only allow for gaps falling within, for example, 2 or 3 standard deviations. However, it will be understood that the system may allow for any number of standard deviations to be considered, depending on how well it is determined that the system operates. The standard deviation may also change as more data is accumulated.

If at decision block 1108 it is determined that there was no new content available from the source, the process 1100 may move to step 1114 to update the predetermined time period accordingly. For instance, since no new content was found and thus the predetermined time period is likely too short of a time period, the adjustment made at step 1114 in response to there being no new content may be to lengthen the predetermined time period by 10%, for example, or some other metric. In other embodiments, if at decision block 1108 it is determined no new content is available from the source, the process 1100 may simply return to step 1104 without adjusting the predetermined time period.

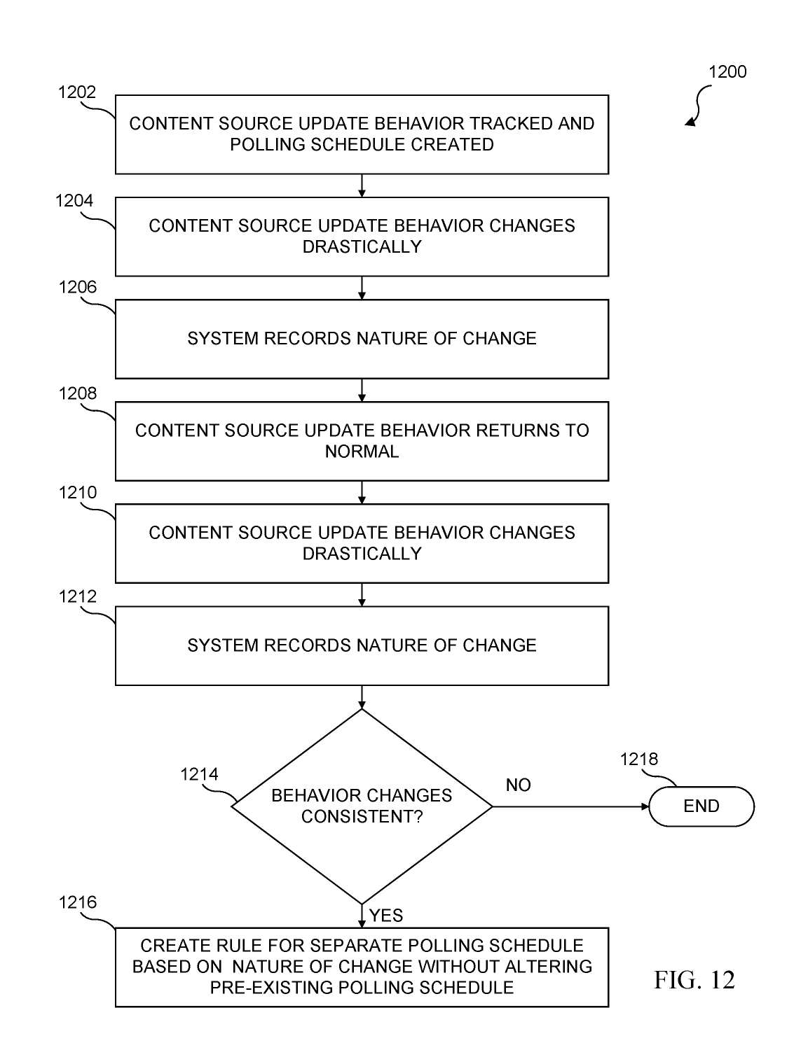

Referring now to FIG. 12, there is illustrated a flowchart of one embodiment of a retrieval frequency trend alteration process 1200. The process 1200 begins at step 1202 where a content sources update behavior (such as frequency) is tracked and a polling schedule is created, such as that described with respect to FIG. 11. At step 1204 the update behavior of the content source changes drastically, deviating substantially from the norm as represented by the previously created polling schedule. This change may be a sudden halting of content updates, a much slower pace of content updates, a much faster pace of content updates, or other changes in frequency. At step 1206, the system records the nature of the change, such as a timestamp for when the change started to occur. At step 1208, the update behavior of the content source returns to normal, more closely resembling the created polling schedule. At step 1210, the content source update behavior changes drastically again. At step 1212, this second content source update behavior change is recorded. At decision block 1214, it is determined whether the source update behavior changes detected are consistent with one another. For instance, the changes may have both occurred around the same time of year, such as both taking place during the months of July and August, with normal update behavior resuming in September. This could signal a seasonal update pattern for the content source. Thus, at step 1216, if the update behavior changes were consistent, the system creates a rule for a new polling schedule based on the nature of the detected changes in update behavior, without altering or eliminating the polling schedule created in step 1202. If the behavior is not consistent, the process ends at step 1218.

For example, if ESPN is a source that has a polling schedule created for it, there may be surges in content updates by ESPN during a major sporting event or season. For instance, there may be many more content updates than usual during the time shortly before, during, and shortly after the NFL Super Bowl. Therefore, the system may create a new seasonal polling schedule, instead of changing the polling schedule in the normal course, such as that described with respect to FIG. 11, which if used may skew the average gap time used for the polling schedule by including these much shorter content gap times. For instance, the seasonal polling schedule for ESPN for the Super Bowl may last from January 15 through February 10, and include a polling rate of every 15 minutes instead of the normal polling schedule's every hour, for example.

This same philosophy could be applied to decreases in polling activity as well. If a YouTube content provider consistently stopped providing updates during the summer months, because that content provider went on vacation every year around the same time, for example, a new polling schedule for that time period for that YouTube content provider may be created, resulting in a schedule that has reduced polling frequency, or even a rule for performing no polls at all during that time. These rules may have an end date where the normal polling schedule resumes, and the seasonal polling schedule is not activated again until a set start time for the schedule or season comes around again.

It will be understood that, while the process 1200 includes two update behavior change events, more than two events may be required before a new rule is created, especially if the update behavior change events are not consistent, or if there is more data needed to create the rule.

It will be understood that there may be a source vetting process that has to be undertaken for new sources added to the system using any of the methods for adding a new source described herein. There may be content limits set by the service provider or by government or regulatory agencies, to ensure that the website or application provided by the service provider is safe for a certain age group or audience, to ensure that obscene or otherwise inappropriate material is not included on the website or application.

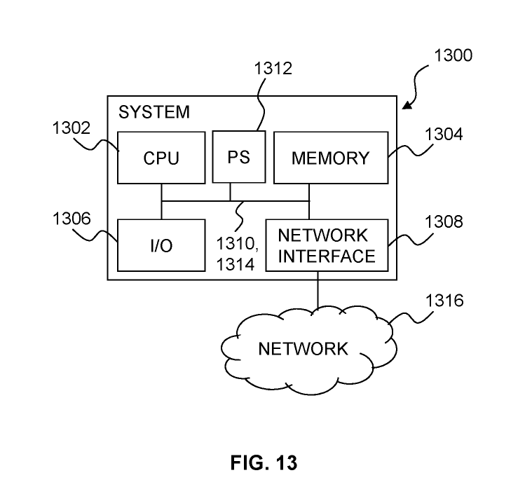

Referring to FIG. 13, one embodiment of a system device 1300 is illustrated. The system device 1300 is one possible example of a device used by an end user 112, a device used by the service provider 106, or one possible example of the remote server 102. Embodiments include cellular telephones (including smart phones), personal digital assistants (PDAs), netbooks, tablets, laptops, desktops, workstations, telepresence consoles, and any other computing device that can communicate with another computing device using a wireless and/or wireline communication link. Such communications may be direct (e.g., via a peer-to-peer network, an ad hoc network, or using a direct connection), indirect, such as through a server or other proxy (e.g., in a client-server model), or may use a combination of direct and indirect communications. It is understood that the device may be implemented in many different ways and by many different types of systems, and may be customized as needed to operate within a particular environment.

The system 1300 may include a controller (e.g., a central processing unit (“CPU”)) 1302, a memory unit 1304, an input/output (“I/O”) device 1306, and a network interface 1308. The components 1302, 1304, 1306, and 1308 are interconnected by a transport system (e.g., a bus) 1310. A power supply (PS) 1312 may provide power to components of the computer system 1300, such as the CPU 1302 and memory unit 1304, via a power system 1314 (which is illustrated with the transport system 1310 but may be different). It is understood that the system 1300 may be differently configured and that each of the listed components may actually represent several different components. For example, the CPU 1302 may actually represent a multi-processor or a distributed processing system; the memory unit 1304 may include different levels of cache memory, main memory, hard disks, and remote storage locations; the I/O device 1306 may include monitors, keyboards, and the like; and the network interface 1308 may include one or more network cards providing one or more wired and/or wireless connections to a network 1316. Therefore, a wide range of flexibility is anticipated in the configuration of the computer system 1300.

The system 1300 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, servers, and embedded devices depending on the use of the system 1300. The operating system, as well as other instructions, may be stored in the memory unit 1304 and executed by the processor 1302. For example, the memory unit 1304 may include instructions for performing some or all of the methods described herein.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for creating a customized web feed from a plurality of sources, comprising:
searching for a content source;
displaying a plurality of content source selections from a source library;
selecting at least one of the plurality of content source selections to be included within the customized web feed;
displaying the at least one of the plurality of content sources;
requesting, if a desired content source is not found within the plurality of content source selections displayed, that the desired content source is added to the source library; and
adding the at least one of the plurality of content source selections to the source library.

2. The method of claim 1, further comprising aligning the at least one of the plurality of content sources according to topic within the customized web feed.

3. The method of claim 1, further comprising analyzing content, feed, and source usage data to establish trending.

4. The method of claim 1, further comprising analyzing content, feed, and source usage data to establish key word and term usage and usage counts.

5. The method of claim 1, further comprising:
analyzing a potential content source to be added to the source library to determine a number of followers and a number of page views;
determining whether the number of followers and page views of the potential content source exceeds a threshold; and
determining whether the potential content source has received a recent update.

6. The method of claim 1, wherein the at least one of the plurality of content source selections is periodically updated to include recent information from a source associated with the at least one of the plurality of content source selections.

7. The method of claim 6, further comprising:
attempting to retrieve updated content from one or more sources in the source library according to an established update frequency;
determining if updated content is available from the one or more sources in the source library; and
altering the established update frequency.

8. The method of claim 7, further comprising comparing a timestamp for previously updated content to a timestamp for currently available content from the one or more sources in the source library.

9. The method of claim 8, wherein altering the established update frequency includes a formulaic evaluation of a plurality of time periods, wherein each time period is an amount of time between each attempted content update.

10. A system for use in creating a customized web feed from a plurality of sources, comprising:
a processor; and
a memory coupled to the processor, the memory containing computer executable instructions for
searching for a content source;
displaying a plurality of content source selections from a source library;
selecting at least one of the plurality of content source selections to be included within the customized web feed;
displaying the at least one of the plurality of content sources;
requesting, if a desired content source is not found within the plurality of content source selections displayed, that the desired content source is added to the source library; and
adding the at least one of the plurality of content source selections to the source library.

11. The system of claim 10, further comprising instructions for aligning the at least one of the plurality of content sources according to topic within the customized web feed.

12. The system of claim 10, further comprising instructions for analyzing content, feed, and source usage data to establish trending.

13. The system of claim 10, further comprising instructions for analyzing content, feed, and source usage data to establish key word and term usage and usage counts.

14. The system of claim 10, further comprising instructions for:
analyzing a potential content source to be added to the source library to determine a number of followers and a number of page views;
determining whether the number of followers and page views of the potential content source exceeds a threshold; and
determining whether the potential content source has received a recent update.

15. The system of claim 10, wherein the at least one of the plurality of content source selections is periodically updated to include recent information from a source associated with the at least one of the plurality of content source selections.

16. The system of claim 15, further comprising instructions for:
attempting to retrieve updated content from one or more sources in the source library according to an established update frequency;
determining if updated content is available from the one or more sources in the source library; and
altering the established update frequency.

17. The system of claim 16, further comprising instructions for comparing a timestamp for previously updated content to a timestamp for currently available content from the one or more sources in the source library.

18. The system of claim 17, wherein altering the established update frequency includes a formulaic evaluation of a plurality of time periods, wherein each time period is an amount of time between each attempted content update.

19. A method for optimizing source content retrieval frequency, comprising:
attempting to retrieve updated content from one or more sources in a source library according to an established update frequency;
comparing a timestamp for previously updated content to a timestamp for currently available content from the one or more sources in the source library;
determining if updated content is available from the one or more sources in the source library; and
performing a formulaic evaluation of a plurality of time periods, wherein each time period is an amount of time between each attempted content update; and
altering the established update frequency.

20. The method of claim 19, further comprising:
determining whether there is an alteration of content update behavior of the one or more sources;
determining whether the alteration of the content update behavior is consistent with previously detected changes in content update behavior of the one or more sources; and
creating an alternate update frequency schedule different from the established update frequency schedule.
